(19) United States
(12) Patent Application Publication
(10) Pub. No.: US 2003/0179980 A1
(43) Pub. Date: Sep. 25, 2003

(54) Optical circuit with ribbonization

(76) Inventor: David R. Baechtle, Dillsburg, PA (US)

Correspondence Address: Tyco Technology Resources, Suite 140, 4550 New Linden Hill Road, Wilmington, DE, 19808-2952, US

(21) Appl. No.: 10/391,944

(22) Filed: Mar. 19, 2003

Related U.S. Application Data
(60) Provisional application No. 60/365,656, filed on Mar. 19, 2002.

(51) Int. Cl. G02B 6/12; G02B 6/44

(52) U.S. Cl. 385/14; 385/114

(57) ABSTRACT

An optical circuit comprising: (a) a substrate having a main body portion and a plurality of port areas; (b) optical fibers affixed to the substrate, each fiber having an end portion which is not affixed to the substrate, the fibers being arranged on the substrate such that two or more groupings of end portions of two or more fibers extend from a port area; and (c) ribbonized legs extending from the substrate, each ribbonized leg containing one of the two or more groupings of end portions.

### REFERENCE TO RELATED APPLICATIONS

The application is based on and claims priority to U.S. Provisional Application No. 60/365,656, filed Mar. 19, 2002, which is hereby incorporated by reference.

### FIELD OF INVENTION

The invention relates generally to optical circuits and, more specifically, to optical circuits suitable for termination to optical connectors.

### BACKGROUND OF THE INVENTION

Optical fiber circuits for particular applications, such as telecommunication router and switching equipment, may be fabricated from individual optical fibers by automated means where the optical fibers are laminated between layers of a substrate, for example, Kapton® (Dupont). The substrate typically comprises a number of tabs and the fibers are arranged on the substrate such that the ends of the fibers are disposed at particular tabs. (See, e.g., U.S. Pat. No. 5,204,925 which describes the formation of an optical circuit in greater detail.) Each tab of fibers may then be terminated to an optical connector to facilitate the optical circuit's connection to other circuit components.

Two options currently exist for terminating the legs of optical fiber circuits. One option involves attaching “pigtails” to the circuit. A pigtail is a connectorized fiber assembly in which the fibers are usually ribbonized. The pigtail may be fusion spliced to the fibers of the tab. This option suffers from several drawbacks, notably the large and inflexible splice protectors used and the fusion splicing equipment.

The second option is to terminate connectors directly to the tabs. Although this approach may be simple in theory, the tabs tend to be bulky because they the fibers are laminated between substrate layers. Consequently, they cannot accept standard termination components and are not compatible with standard terminating equipment and tooling. Standard termination components, equipment and tooling are designed to be used with bare ribbon and the dimensions of the tabs are wider and thicker than the standard bare ribbon. Accordingly, customized tooling and components are needed to effect termination of such non-standard circuit tabs, increasing the cost and time necessary for manufacture.

Therefore, there is a need for an improved method of manufacturing optical circuits that allows the use of standard terminating components, tooling and equipment. The present invention fulfills this need among others.

### SUMMARY OF INVENTION

The present invention provides for an optical circuit having ribbonized legs which facilitate easy fiber termination to standard connectors using standard termination tools and techniques.

One aspect of the invention is an optical circuit comprising ribbonized legs extending therefrom. In a preferred embodiment, the optical circuit comprises (a) a substrate having a main body portion and a plurality of port areas; (b) optical fibers affixed to the substrate, each fiber having an end portion which is not affixed to the substrate, the fibers being arranged on the substrate such that two or more groupings of end portions of two or more fibers extend from a port area; and (c) ribbonized legs extending from the substrate, each ribbonized leg containing one of the two or more groupings of end portions. Preferably, the optical circuit also comprises one or more connectors, each connector being attached to a particular ribbonized leg such that the end portions of fibers in the particular ribbonized leg are suitable for optical coupling to other optical components.

Another aspect of the present invention is a method for preparing the optical circuit having ribbonized legs. In a preferred embodiment, the method comprises: (a) providing an intermediate optical circuit comprising a substrate having a main body portion and a plurality of port areas, and optical fibers affixed to the substrate, each fiber having an end portion which is not affixed to the substrate, the fibers being arranged on the substrate such that two or more groupings of end portions of two or more fibers extend from a port area; and (b) ribbonizing each grouping extending from the substrate into a ribbonized leg. Typically, the intermediate optical circuit comprises a tab for each port area. In such an embodiment, the method of the present invention further comprising removing at least a portion of the tab without damaging the fibers associated therewith. In a preferred embodiment, the method further comprising connectorizing each ribbonized leg with a connector.

### BRIEF DESCRIPTION OF DRAWINGS

FIG. 1 is a plan view of a substrate having slits cut at various predetermined locations;

FIG. 2 is a plan view of the substrate shown in FIG. 1 with signal carrying members attached along predetermined paths on the substrate;

FIG. 3 is a plan view of the substrate shown in FIGS. 1 and 2 with cuts made lengthwise and adjacent to the signal carrying members between the slits;

FIG. 4 is a plan view of the signal carrying members with the substrate removed; and

FIG. 5 is a plan view of a signal carrier comprising ribbonized signal carrying members.

FIG. 6 is a schematic view of a preferred embodiment of the optical circuit of the present invention having a plurality of ribbonized legs which are connectorized.

### DETAILED DESCRIPTION OF PREFERRED EMBODIMENT

Referring to FIG. 6, a preferred embodiment of the optical circuit 60 of the present invention is shown. The optical circuit comprises 60 a flexible substrate 61 having a main body portion 61a and a plurality of port areas 61b and optical fibers 62 affixed to the substrate 61. Each fiber has an end portion 62a which is not affixed to the substrate 61. The fibers 62 are arranged on the substrate 61 such that two or more groupings 63 of end portions 62a of two or more fibers extend from a port area 61b. The optical circuit 60 also comprises ribbonized legs 64 extending from the substrate 61. Each ribbonized leg 64 contains one of the two or more groupings 63 of end portions.

In a preferred embodiment, the optical circuit 60 also comprises one or more connectors 65. Each connector 65 is attached to a particular ribbonized leg 63 such that the end portions of fibers in the particular ribbonized leg are suitable for optical coupling to a mating connector or adapter. More preferably, at least some of the connectors are MT-type connectors. In the most preferred embodiment, the MT-type connectors are MPX connectors available from Tyco Electronics Corporation (Harrisburg, Pa.) as the Lightray MPX® connector.

To facilitate connection to a connector, the fibers at the end of the ribbonized leg preferably have a particular centerline distance consistent with the requirements of the connector. For example, the MPX connector requires a fiber centerline distance of 0.250 mm. The centerline distance among the fibers in a particular grouping at a port area may or may not be the same as the particular centerline distance.

In a preferred embodiment, the fibers are continuous from the substrate to the ends of the ribbonized legs. The term “continuous” as used in this context means that there are no fiber splices or interconnections along the fiber length.

The details of the optical circuit of the present invention may be better understood by considering the method in which the optical circuit is prepared. The following is a detailed description of one approach for preparing the optical circuit of the present invention. It should be understood, however, that this method is provided for illustrative purposes and that the invention is not limited to this particular method and alternative methods are within the scope of the invention.

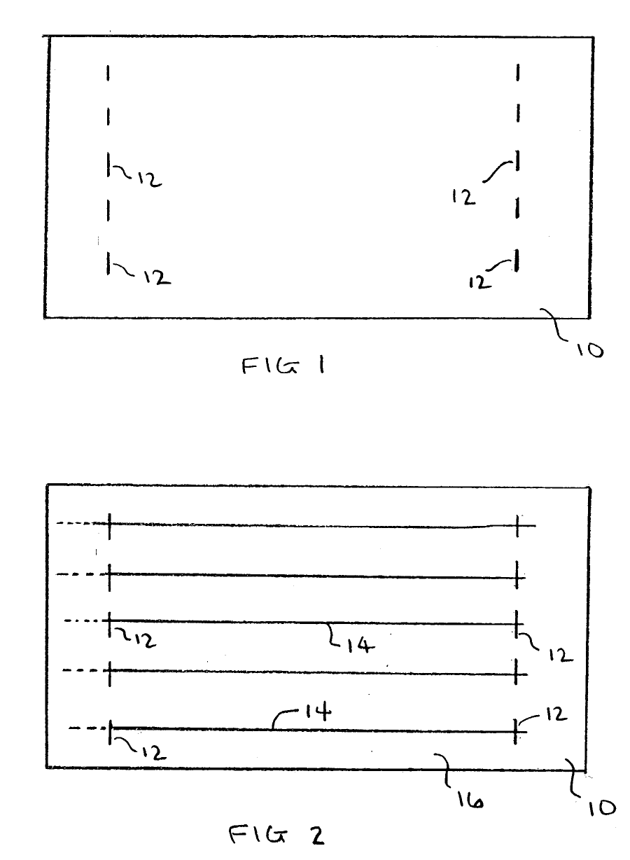

The first step is to provide an intermediate optical circuit having a substrate layer 10 and signal carrying members 14 (in this case fibers) as shown in FIG. 1. Substrate 10 preferably comprises a thin, flexible, resilient membrane of a dimensionally stable material such as Kapton®. Other materials, including thermoplastic polymers such as polypropylene, polyethylene and the like are also feasible.

Substrate layer 10 is prepared by cutting a plurality of slits 12 through the layer at various locations. Cutting of the slits 12 is preferably effected by a computer controlled laser cutter mounted on a cross head movable precisely in two orthogonal directions above the plane of the substrate under the control of software to position the slits 12 at precise predetermined locations required as described below. Other methods of cutting the slits 12, including, for example, die cutting, are also feasible.

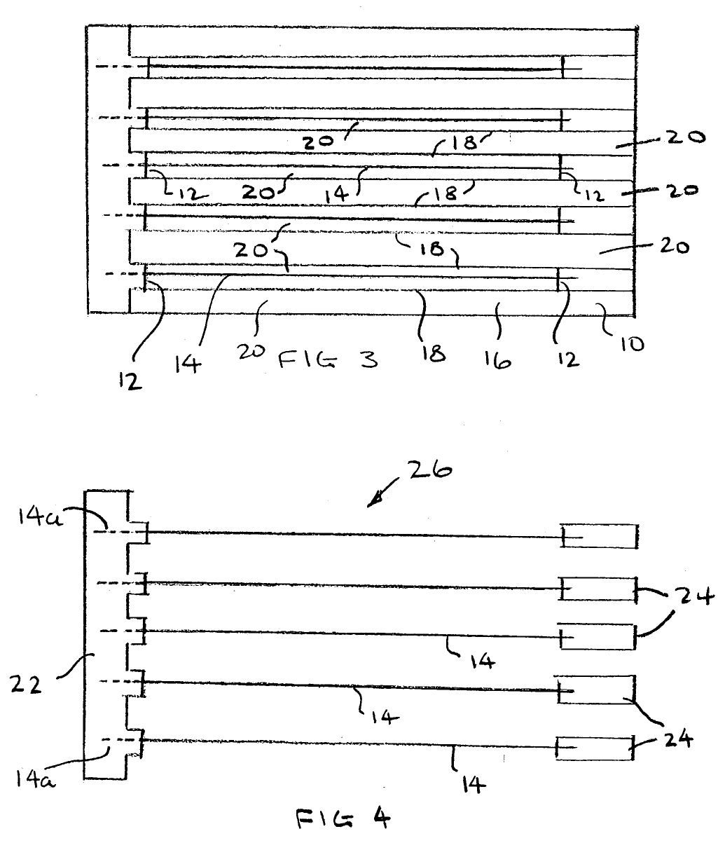

In a subsequent step, shown in FIG. 2, signal-carrying members 14 are attached to the substrate 10, preferably by an adhesive layer 16 resident on the substrate. The signal carrying members 14 may be any elongated item which carries signals, such as optical fibers transmitting modulated light signals. The members 14 could also comprise electrically conducting wires as well or a combination of different types of signal carriers. The signal carrying members 14 are laid onto the substrate 10 by means of automated machinery under computer control, the machinery having a cross head movable in mutually orthogonal directions to follow a path as determined by software and which defines a circuit, or a portion thereof, comprised of signal carriers (described below) formed by groupings of signal carrying members 14. The paths along which each of the signal carrying members 14 are laid transversely cross one of the slits 12 at least two points along the path.

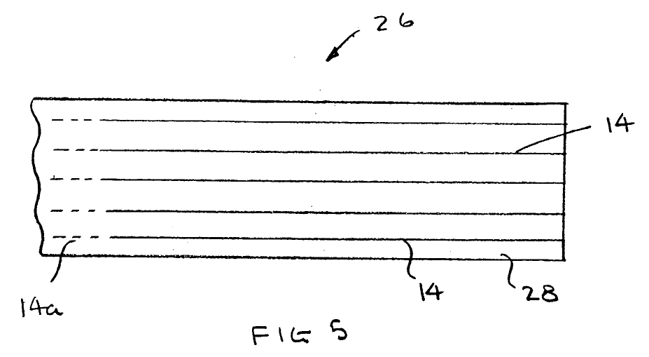

In the step shown in FIG. 3, the laser cutter is again preferably employed to make cuts 18 lengthwise along and adjacent to each of the signal carrying members 14 between the slits 12. Cuts 18 intersect the slits 12 to create various substrate regions 20 of the substrate 10 which can be removed from the substrate and release the signal carrying members from one another substantially between the slits 12. FIG. 4 shows the signal carrying members 14 with the substrate regions 20 removed. Tabs 22 and 24 remain attached to portions of the signal carrying members, with one of the tabs 22 being substantially in one piece and commonly attached to the signal carrying members 14 to maintain them as a grouping of signal carrying members 14 together and thereby define a signal carrier 26 as a grouping of signal carrying members 14. The other tabs 24 are attached as individual tabs to the terminal ends of the signal carrying members 14 and permit them to be grasped, pulled, straightened and otherwise arranged for the ribbonization step described below. Unlike the tabs 24, the tab 22 is not necessarily attached to terminal ends of the signal carrying members 14 as indicated by broken line portions 14a which represent signal carrying members which extend indefinitely to other portions or signal carriers in the circuit of which signal carrier 26 is a part.

When attached to the substrate 10, the signal carrying members 14 are organized into signal carriers 26, each comprised of a convenient grouping of a plurality of signal carrier members 14. Preferably, a standard number of signal carrying members 14 are arranged relative to one another so that they form a standard signal carrier 26 having a standard number of signal carrying members 14 arranged in spaced relation to one another so that the signal carrier has standard dimensions compatible with standard components, equipment and tooling for termination and splicing with other signal carriers comprising a circuit or a device.

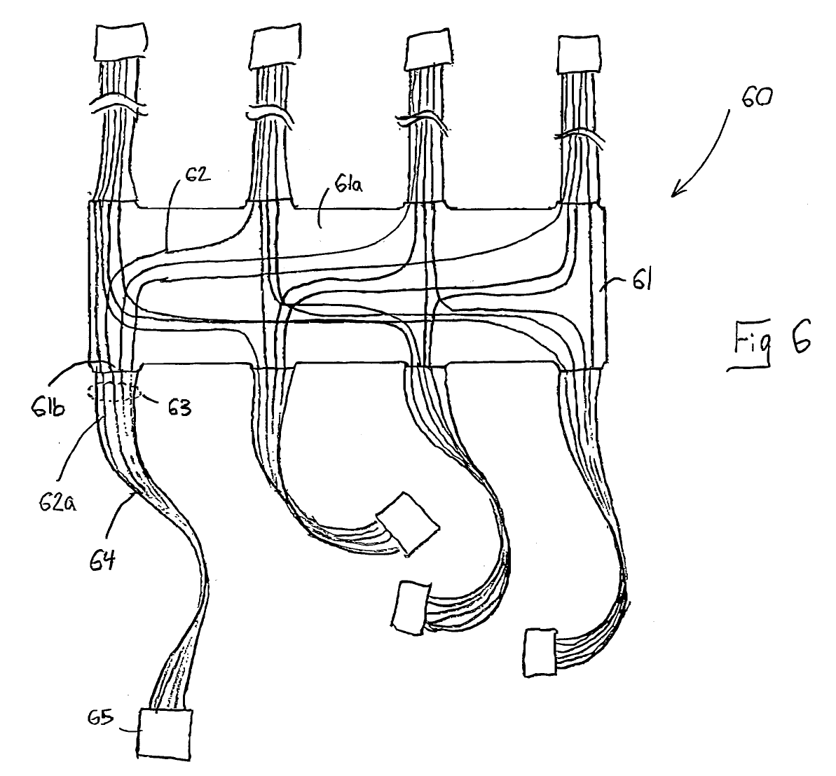

To permanently preserve the groupings of signal carrying members 14 into signal carriers 26, the signal carrying members are “ribbonized” as shown in FIG. 5 by encasing them in a flexible resin 28 which bonds the signal carrying members together. The bonding or ribbonizing is preferably done by encapsulating the signal carrying members forming each signal carrier 26 in an adhesive, such as an ultraviolet ray curable acrylate, while removing the tabs 22 and 24.

Once the signal carriers 26 are ribbonized and the tabs 22 and 24 are removed the signal carrier can be terminated for connection into the communication network for which the optical circuit was designed. The termination of the ribbons may proceed using standard termination components, tooling and equipment since the ribbons were formed according the standard for which the equipment, tooling and components are designed.

What is claimed is:

1. An optical circuit comprising:
a substrate having a main body portion and a plurality of port areas;
optical fibers affixed to said substrate, each fiber having an end portion which is not affixed to said substrate, said fibers being arranged on said substrate such that two or more groupings of end portions of two or more fibers extend from a port area; and
ribbonized legs extending from said substrate, each ribbonized leg containing one of said two or more groupings of end portions.

2. The optical circuit of claim 1, further comprising:
one or more connectors, each connector being attached to a particular ribbonized leg such that the end portions of fibers in said particular ribbonized leg are suitable for optical coupling to a mating connector.

3. The optical circuit of claim 2, wherein said connectors are MT-type connectors.

4. The optical circuit of claim 3, wherein at least a portion of said connectors are MPX connectors.

5. The optical circuit of claim 1, wherein the centerline distance among fibers in a particular grouping at a port area is not the same as the centerline distance among the fibers at the end of the ribbonized leg of said particular grouping of fibers.

6. The optical circuit of claim 1, wherein the centerline distance among fibers in a particular grouping at a port area is the same as the centerline distance among the fibers at the end of the ribbonized leg of said particular grouping of fibers.

7. The optical circuit of claim 1, wherein there are no fiber splices or interconnections in the fiber from said substrate to one or more of the connectors.

8. The optical circuit of claim 7, wherein there are no fiber splices or interconnections in the fiber from said substrate to all of the connectors.

9. The optical circuit of claim 1, wherein said substrate is flexible.

10. A method of fabricating an optical circuit comprising:
providing an intermediate optical circuit comprising a substrate having a main body portion and a plurality of port areas and optical fibers affixed to said substrate, each fiber having an end portion which is not affixed to said substrate, said fibers being arranged on said substrate such that two or more groupings of end portions of two or more fibers extend from a port area;
ribbonizing each grouping extending from said substrate into a ribbonized leg.

11. The method of claim 10, wherein said substrate of said intermediate optical circuit comprises a tab for each port area, said method further comprising removing at least a portion of said tab without damaging the fibers associated therewith.

12. The method of claim 10, further comprising connectorizing each ribbonized leg with a connector.

13. The method of claim 12, wherein said connector is an MPX connector

14. The method of claim 13, wherein said connector is an MPX connector

15. The method of claim 10, wherein ribbonizing comprises arranging the fibers of the end portions at a predetermined centerline distance with respect to each other, said predetermined centerline distance being suitable for connectorization.

16. A method of fabricating a signal carrier having a plurality of elongated signal carrying members each having a terminal end, said method comprising the steps of:
providing a substrate;
cutting a plurality of slits through said substrate at predetermined locations thereon;
attaching the plurality of signal carrying members to said substrate, each of said signal carrying members extending between two of said slits positioned in spaced relation to one another, each of said terminal ends overlying and being oriented transversely to a respective slit;
cutting said substrate lengthwise along and adjacent to each of said signal-carrying members between said slits;
removing said substrate from said signal carrying members between said slits thereby separating said signal carrying members from one another between said slits, portions of said substrate adjacent to said slits remaining attached to said signal carrying members;
encapsulating said elongated signal carrying members between said substrate portions within a flexible resin thereby forming a ribbon of elongated signal carrying members; and
removing said portions of said substrate from said signal carrying members.

17. The method of claim 16, further comprising connectorizing each ribbonized leg with a connector.

18. The optical circuit prepared from the method of claim 17.

19. The optical circuit prepared from the method of claim 16.
